(19) United States
(12) Patent Application Publication
(10) Pub. No.: US 2026/0127422 A1
(43) Pub. Date: May 7, 2026

(54) BIAS CURRENT GENERATION CIRCUIT COMPRISING SELF-CORRECTION CIRCUIT, APPARATUS COMPRISING SPIKE NEURAL NETWORK DRIVEN BASED THEREON, AND METHOD FOR CORRECTING BIAS CURRENT

(71) Applicant: Electronics and Telecommunications Research Institute, Daejeon (KR)

(72) Inventors: Kwang IL OH, Daejeon (KR); Hyuk Kim, Daejeon (KR); Jae-Jin Lee, Daejeon (KR)

(73) Assignee: Electronics and Telecommunications Research Institute, Daejeon (KR)

(21) Appl. No.: 19/369,400

(22) Filed: Oct. 27, 2025

(30) Foreign Application Priority Data
Nov. 6, 2024 (KR) 10-2024-0156305

(51) Int. Cl. G06N 3/065; G06N 3/0442; G06N 3/049

(52) U.S. Cl. CPC G06N 3/065; G06N 3/0442; G06N 3/049

(57) ABSTRACT

An apparatus comprises a bias current generation circuit configured to generate a bias current, a synapse circuit including a weight register storing a weight value and configured to perform a charge operation based on the input spike signal, the bias current, and the weight value, a membrane capacitor having a potential determined based on the charge operation of the synapse circuit, and a neuron circuit configured to generate an output spike signal based on a comparison between the potential of the membrane capacitor and a threshold potential. The bias current generation circuit comprises a self-correction circuit, and the self-correction circuit comprises a target input spike register storing a value related to a target number of input spikes and is configured to correct the bias current generated by the bias current generation circuit based on the value related to the target number of input spikes.

### CROSS-REFERENCE TO RELATED APPLICATIONS

This application claims priority under 35 U.S.C. § 119 to Korean Patent Application No. 10-2024-0156305 filed on November 6, 2024 in the Korean Intellectual Property Office, the disclosures of which are incorporated by reference herein in their entireties.

### BACKGROUND

The present disclosure relates to a spiking neural network circuit, and more particularly, to a bias current generation circuit comprising a self-correction circuit, an apparatus comprising a spiking neural network driven based on the bias current generation circuit, and a method for correcting a bias current.

An artificial neural network (ANN) can process data or information in a manner similar to that of a biological neural network. Unlike a perceptron-based or convolution-based neural network, in a spiking neural network (SNN), a signal of a specific level is not transmitted continuously; instead, a spike signal including pulses that toggle for a short duration is transmitted.

A spiking neural network circuit may be implemented using semiconductor devices. However, when implemented as a semiconductor circuit, the spiking neural network circuit may be affected by environmental factors (for example, temperature, humidity, or changes in supply voltage), which can cause errors in the computational results of the spiking neural network. Therefore, there is a need for a spiking neural network circuit capable of self-correction that compensates for variations in environmental conditions after the circuit has been fabricated.

### SUMMARY

An object of the present disclosure is to provide a bias current generation circuit comprising a self-correction circuit, an apparatus comprising a spiking neural network driven based on the bias current generation circuit, and a method for correcting a bias current.

According to an embodiment of the present disclosure, an apparatus may include a bias current generation circuit configured to generate a bias current, a synapse circuit including a weight register storing a weight value and configured to perform a charge operation based on an input spike signal, the bias current, and the weight value, a membrane capacitor having a potential determined based on the charge operation of the synapse circuit, and a neuron circuit configured to generate a first output spike signal based on a comparison between the potential of the membrane capacitor and a threshold potential. The bias current generation circuit includes a self-correction circuit, which includes a target input spike register, and the self-correction circuit corrects the bias current generated by the bias current generation circuit based on a value related to a target number of input spikes stored in the target input spike register.

In one embodiment, the bias current generation circuit may include a first group of transistors forming a synapse bias path for providing the bias current to the spiking neural network circuit, a second group of transistors forming a current correction path configured as a same current mirror as the first group of transistors, a third group of transistors for controlling the bias current, and a self-correction circuit configured to provide a control signal corresponding to a binary code for correcting the bias current to the third group of transistors. In an example, the self-correction circuit may include a replica synapse circuit configured to receive an input spike signal from an axon line and perform a charge operation, a replica membrane capacitor having a potential determined based on the charge operation of the replica synapse circuit, a replica neuron circuit configured to generate an output spike signal based on the potential of the replica membrane capacitor, an input spike counter configured to receive the input spike signal from the axon line and the output spike signal from the replica neuron circuit, and to count the number of spikes of the input spike signal until the output spike signal is generated, a target input spike register configured to store a value related to a target number of input spikes, a comparator configured to compare the counted number of spikes with the target number of input spikes, and a binary code bit controller configured to modify the binary code based on the comparison result.

In one embodiment, a method for correcting a bias current provided to a spiking neural network circuit may include receiving, by a replica synapse circuit and an input spike counter, an input spike signal from an axon line, receiving, by the input spike counter, an output spike signal generated by a replica neuron circuit based on the input spike signal and a bias current determined according to a binary code, counting, by the input spike counter, the number of spikes in the input spike signal until the output spike signal is generated, comparing, by a comparator, the counted number of spikes with a target number of input spikes, and modifying, by a binary code bit controller, the binary code based on the comparison result.

### BRIEF DESCRIPTION OF THE FIGURES

The above and other objects and features of the present disclosure will become apparent by describing in detail embodiments thereof with reference to the accompanying drawings.

FIG. 1 is a schematic diagram illustrating an apparatus according to an embodiment of the present disclosure.

FIG. 2 is a schematic diagram illustrating a synapse circuit according to an embodiment of the present disclosure.

FIG. 3 is a timing diagram illustrating the operation of a synapse circuit and a neuron circuit according to input spike signals applied through axon lines.

FIG. 4 is a schematic diagram illustrating an I-DAC of FIG. 2 according to an embodiment of the present disclosure.

FIG. 5 is a schematic diagram illustrating a bias current generation circuit of FIG. 1 according to an embodiment of the present disclosure.

FIG. 6 is a schematic diagram illustrating a self-correction circuit of FIG. 5 according to an embodiment of the present disclosure.

FIG. 7 is a schematic diagram illustrating a replica synapse circuit of FIG. 6 according to an embodiment of the present disclosure.

FIG. 8 is a table exemplarily showing a binary code B_code<7:0> according to an embodiment of the present disclosure.

FIG. 9 is a timing diagram illustrating operation waveforms for describing the operation of the self-correction circuits of FIGS. 5 and 6 according to an embodiment of the present disclosure.

FIG. 10 is a flowchart exemplarily illustrating a method for correcting a bias current according to an embodiment of the present disclosure.

### DETAILED DESCRIPTION

Hereinafter, embodiments of the present disclosure will be clearly and elaborately described to the extent that a person skilled in the art to which the present disclosure pertains can easily carry out the present disclosure.

Terms such as "unit" and "module" used hereinafter, or functional blocks shown in the drawings, may be implemented in the form of a software configuration, a hardware configuration, or a combination thereof. In the following description, detailed descriptions of redundant components will be omitted in order to clearly explain the technical idea of the present invention.

In this document, each of phrases such as "A or B", "at least one of A and B", "at least one of A or B", "A, B or C", "at least one of A, B and C", and "at least one of A, B, or C" may include any one of the items listed together in the corresponding phrase or all possible combinations thereof.

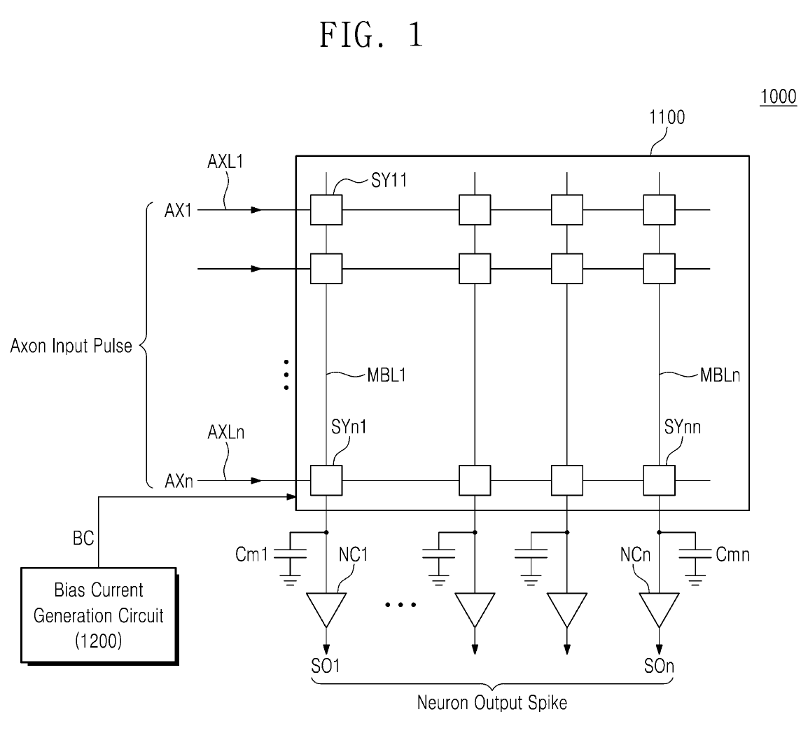

FIG. 1 is a schematic diagram illustrating an apparatus according to an embodiment of the present disclosure. The apparatus 1000 may include a spiking neural network circuit 1100 configured to generate an output spike signal based on an input spike signal (axon input pulse) received from axon lines AXL1–AXLn. The apparatus 1000 may further include membrane capacitors Cm1–Cmn, neuron circuits NC1–NCn, and a bias current generation circuit 1200. The apparatus 1000 may also include axon lines AXL1–AXLn and membrane lines MBL1–MBLn. In this document, the term axon may also be referred to as an axonal projection, and membrane may also be referred to as a cell membrane. The terms “axon line” and “membrane line” may be simply referred to as “axon” and “membrane”, respectively.

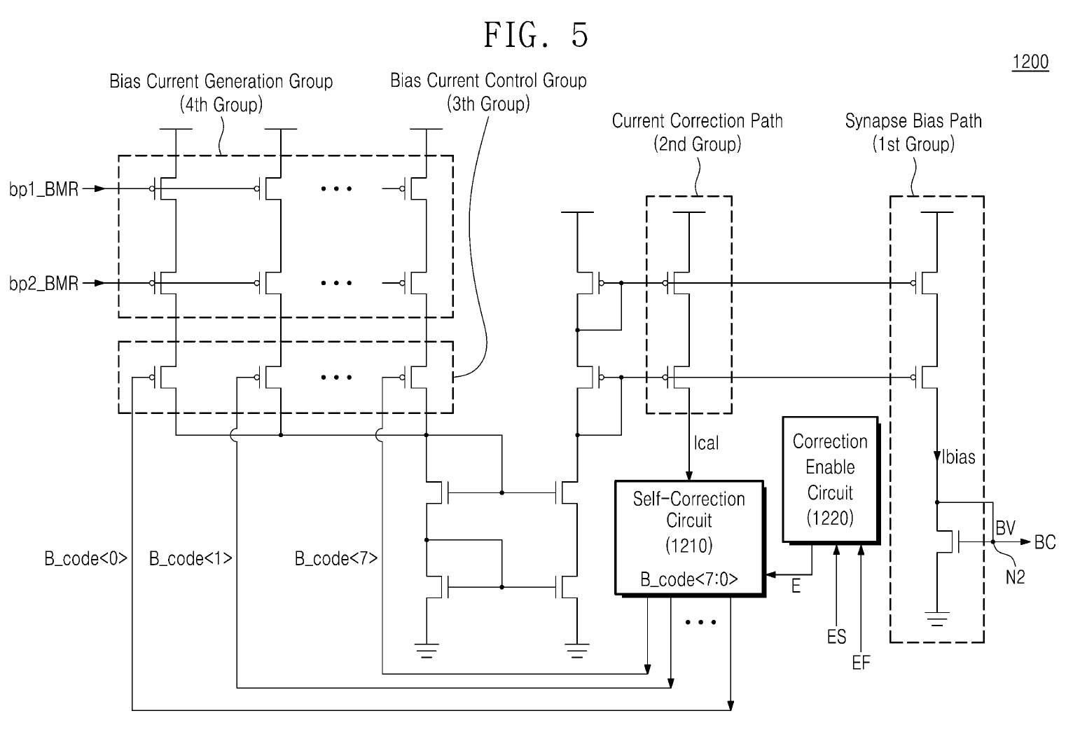

The bias current generation circuit 1200 may generate a bias current. For a node (gate) on a synapse circuit SY11–SYnn connected to the bias current generation circuit 1200, a bias voltage may be determined by the bias current generation circuit 1200. A more detailed schematic of the synapse bias current generation circuit 1200 according to an embodiment is shown in FIG. 5.

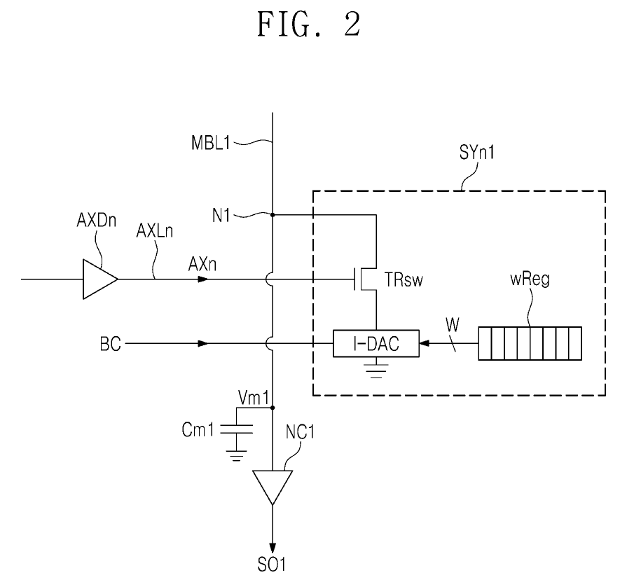

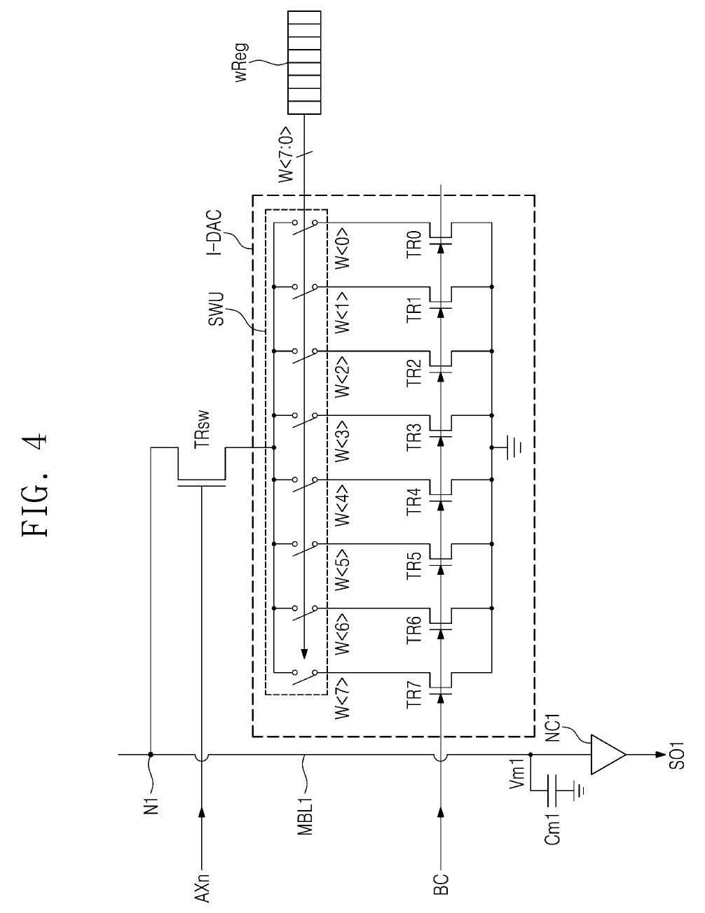

The spiking neural network circuit 1100 may include synapse circuits SY11–SYnn. The synapse circuits SY11–SYnn may perform charge operations based on the input spike signal, the bias current, and a weight value (described below with FIG. 2 and FIG. 4). In this document, the term synapse circuit may also be simply referred to as synapse. A more detailed schematic of a synapse circuit according to an embodiment is shown in FIGS. 2 and 4.

The membrane capacitors Cm1–Cmn may accumulate charge based on the charge operations performed by the synapse circuits SY11–SYnn, and a potential of each membrane capacitor may be determined accordingly. In the present disclosure, the term membrane capacitor may also be simply referred to as capacitor.

The neuron circuits NC1–NCn may generate output spike signals SO1–SOn (neuron output spikes) based on comparisons between the potentials of the membrane capacitors Cm1–Cmn and a threshold potential. In this document, the term neuron circuit may also be simply referred to as neuron. The threshold potential may be predetermined by a designer during the circuit design stage and may be supplied to the neuron circuits NC1–NCn by a power supply.

Referring to FIG. 1, the spike neural network 1100 may generally include the axon lines AXL1–AXLn corresponding to the inputs of the network, the neurons NC1–NCn corresponding to the outputs of the network, and the plurality of synapses SY11–SYnn connecting the axon lines AXL1–AXLn and the neurons NC1–NCn. The synapses SY11–SYnn determine whether a connection exists between the axon lines AXL1–AXLn and the dendrites (inputs) of the neurons NC1–NCn, as well as the strength of such connections. The input of a particular neuron forms a membrane MBL1–MBLn, which is composed of the dendrites and the weighted synapses SY11–SYnn associated therewith. Each membrane accumulates the signals transmitted from the synapses SY11–SYnn and provides the accumulated signal as an input to the corresponding neuron NC1–NCn.

The axon lines AXL1–AXLn, serving as the inputs of the network, receive input signals in the form of pulses having short time widths in the spike neural network 1100. A degree of signal accumulation on the membranes MBL1–MBLn, which serve as inputs to the neurons NC1–NCn, is determined by the application period of the pulses. In addition, the degree of signal accumulation on the membranes MBL1–MBLn in response to each unit axon input pulse AX1–AXn is determined by synaptic weights, which define correlations between the input pulses AX1–AXn from the synapses SY11–SYnn and the corresponding subsequent neurons NC1–NCn. The membrane signal of a particular neuron corresponds to a sum of accumulated signals transmitted through the dendrites connected to the same membrane and is provided as an input to the neuron. The neuron then compares the membrane signal with a firing threshold potential (also referred to as a threshold voltage or critical potential) to determine whether the neuron fires based on whether the accumulated potential exceeds the threshold.

The spike neural network 1100 according to an embodiment of the present disclosure is based on a semiconductor circuit structure that performs analog charge computation. For this purpose, a current amount adjusted by the weights according to input spike signals AX1–AXn is transmitted from the synapses SY11–SYnn to the membrane capacitors Cm1–Cmn, thereby causing the potential of the membrane lines MBL1–MBLn to increase. To stably supply synaptic currents from the respective synapses to the membrane capacitors, a bias current generation circuit 1200 is provided, which supplies a reference bias current BC to the current sources of the respective synapses.

FIG. 2 is a schematic diagram illustrating a synapse circuit according to an embodiment of the present disclosure. FIG. 2 shows, as an example, the synapse circuit SYn1 of FIG. 1 in detail, and will be described in conjunction with FIG. 1. The synapse circuit SYn1 may include a current-mode digital-to-analog converter I-DAC, a weight register wReg, and a synapse transistor TRsw. A membrane line MBL1, a membrane capacitor Cm1, and synapse circuits SY11–SYn1 may form a single synapse column.

The synapse circuit SYn1 may be connected to a neuron circuit NC1 through the membrane line MBL1. The synapse circuit SYn1 and the capacitor Cm1 may be connected to the membrane line MBL1 through a node N1. The synapse circuit SYn1 may also be connected to an axon line AXLn and receive an input spike signal AXn from an axon driver AXDn. The input spike signal AXn may be applied to a gate of the synapse transistor TRsw.

The synapse circuit SYn1 may generate an operation signal based on a weight value W of the synapse circuit and the input spike signal AXn. The synapse SYn1 may output the operation signal to the membrane line MBL1. The membrane capacitor Cm1 may be charged by the operation signal output from the synapse SYn1. A potential Vm1 of the capacitor Cm1 may correspond to an amount of accumulated charge according to the operation signals output from the synapse circuits SY11–SYn1. The potential Vm1 of the capacitor Cm1 may be provided to the neuron (NC1), and may be equivalent to the potential of the membrane line MBL1.

The neuron circuit NC1 may compare the magnitude of the operation signals output from the synapses SY11–SYn1 connected to the corresponding synapse column with a threshold potential. For example, the neuron circuit NC1 may compare the potential Vm1 of the capacitor Cm1 with the threshold potential. Based on the comparison result, the neuron circuit NC1 may generate an output signal SO1. In one embodiment, when the potential Vm1 of the capacitor Cm1 is less than the threshold potential, the neuron circuit NC1 may generate a pulse (output spike signal).

Referring to FIGS. 1 and 2, in a spiking neural network 1100 operating based on charge computation, input spikes AX1–AXn are applied through multiple axons AXL1–AXLn, and output spikes SO1–SOn, which are results of computation, are generated by multiple neurons NC1–NCn. To form a network between the multiple axons AX1–AXn and neurons NC1–NCn, synapses SY11–SYnn are provided at each intersection point. Each synapse SY11–SYnn is structured to perform charge operations so as to supply charge to the membrane capacitors Cm1–Cmn in accordance with the stored weight value W at the time of receiving an axonal input spike AX1–AXn. That is, each synapse SY11–SYnn may be implemented as an I-DAC, which performs charge operations. Each I-DAC converts a binary weight value stored in its synapse register wReg into a current corresponding to the weight magnitude, and supplies charge to the membrane capacitors Cm1–Cmn.

In this document, the bit width of the synapse register wReg and the I-DAC implemented in each synapse SY11–SYnn is illustrated as 8 bits merely as an example, but is not limited thereto. Various bit widths may be employed depending on a task to which the implemented spiking neural network 1100 is applied. Each implemented synapse SY11–SYnn belongs to a synapse column distinguished by the neuron connected to the corresponding synapse outputs. Each synapse SY11–SYnn receives a reference bias current BC supplied from the bias current generation circuit 1200. The supplied synapse bias current BC is used as a bias current for operating the current source that supplies charge from each synapse SY11–Synn to the membrane capacitors Cm1–Cmn.

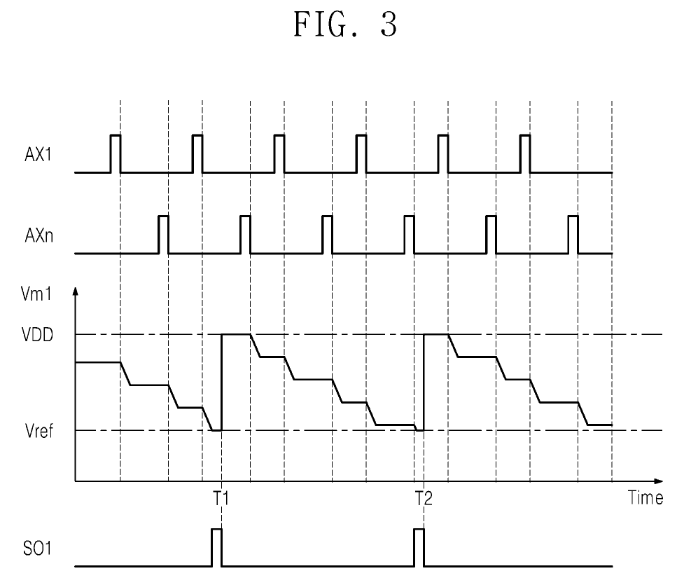

FIG. 3 is a timing diagram illustrating the operation of a synapse circuit and a neuron circuit according to input spike signals applied through axon lines. This example illustrates a method in which charge computation occurs as the potential of a membrane capacitor decreases in response to the application of input spike signals. FIG. 3 relates to the device described with reference to FIGS. 1 and 2.

As described in FIG. 1, in the device including the spiking neural network 1100, when input spike signals AX1–AXn are applied through the axon lines AXL1–AXLn of the spiking neural network 1100, a reduction in charge occurs in the membrane capacitor Cm1 connected to the neuron circuit NC1. The amount of charge reduction may be determined by the magnitude of the weight value W stored in each synapse SY11–SYn1.

In the example of FIG. 3, a timing diagram is shown in which input spike signals are applied to the first axon line AXL1 and the nth axon line AXLn at different time points. Assuming that the same weight value is stored in each synapse, the decrease in the membrane potential Vm1 is illustrated according to the timing of each spike input (AX1, AXn). As the input spike signals AX1and AXn are applied to the respective axon lines AXL1 and AXLn, the membrane potential Vm1 decreases, and when the membrane potential Vm1 becomes less than the threshold potential Vref of the neuron NC1, the neuron NC1 fires and outputs a spike SO1. Afterward, upon receiving a neuron reset signal, the membrane potential Vm1 is recharged to its initial value VDD. The frequency and timing of spikes output from the neuron may vary depending on the timing of the input spikes and the magnitudes of the weights stored in the synapses.

FIG. 4 is a schematic diagram illustrating an I-DAC of FIG. 2 according to an embodiment of the present disclosure. FIG. 4 illustrates an I-DAC implemented in a spiking neural network operating based on charge computation, and shows a schematic of a unit synapse circuit including an 8-bit weight switch. The I-DAC may include transistors TR0–TR7 and switches connected in series with each of them. The transistors TR0–TR7 of the I-DAC are connected in parallel to one another, and each transistor receives a bias current BC from the bias current generation circuit 1200. For example, the gate voltages of the transistors TR0–TR7 in the I-DAC may be determined as a bias voltage BV by the bias current generation circuit 1200.

The synapse SYn1 may generate an operation signal based on the input spike signal AXn and the weight W<7:0>. The magnitude of the operation signal may be determined by a product of the input spike signal AXn and the weight W<7:0>. For example, the operation signal may be a current signal corresponding to the product of the input spike signal AXn and the weight W<7:0>.

The weight register wReg may store bits W<7:0> corresponding to the weights. In some embodiments, the weight register wReg may include registers, memory cells, latches, or NAND flash memory cells. For example, the weight register wReg may provide to the I-DAC a digital signal corresponding to the weight W<7:0> of the synapse SYn1.

The multiple bits W<7:0> stored in the weight register wReg may be converted by the I-DAC of the synapse SYn1 into an analog signal (for example, a voltage or current signal) corresponding to the weight W<7:0>.

The I-DAC may generate a current corresponding to the weight W<7:0> of the synapse SYn1. In some embodiments, the I-DAC may include transistors TR0–TR7 (which may also be referred to as multiple current sources) and a switch unit SWU connected between a ground terminal and the synapse transistor TRsw.

The transistors TR0 to TR7 (which may also be referred to as a plurality of current sources) may be connected between the switch unit SWU and a ground terminal. In one embodiment, the transistors TR0 to TR7 may generate currents having different magnitudes. In another embodiment, the transistors TR0 to TR7 may generate currents that increase in magnitude by powers of two.

For example, the magnitude of the current generated by TR7 may be twice that of the current generated by TR6, and four times that of the current generated by TR5.

In one embodiment, the transistors TR0–TR7 may generate currents based on the bias current BC and/or the bias voltage BV. For example, the magnitudes of the bias current BC and/or the bias voltage BV may be proportional to the magnitudes of the currents generated by the respective transistors TR0–TR7.

The switch unit SWU may receive signals W<7:0> corresponding to the weights from the weight register wReg. For example, the switch unit SWU may be implemented using multiple transistors (for example, PMOS transistors). The switch unit SWU may be connected between the transistors TR0–TR7 and the synapse transistor TRsw. The switches in the switch unit SWU may be opened or closed under the control of the weight W<7:0>. Through a closed switch and the corresponding connected transistor (for example, TR7), a current based on the bias current BC may flow toward the ground terminal. The magnitude of the current flowing through the ground terminal from the I-DAC may cause the operation result of the synapse SYn1.

The synapse transistor TRsw may be turned on based on the input spike signal AXn. When the synapse transistor TRsw is turned on according to the input spike signal AXn, it may output, to the membrane line MBL1, the current (i.e., operation signal) output from the I-DAC corresponding to the input spike signal AXn. In some embodiments, the synapse transistor TRsw may be implemented using PMOS, NMOS, or a combination thereof.

That is, when the input spike signal AXn is applied and the synapse transistor TRsw is turned on, the synapse circuit SYn1 may deliver to the neuron circuit NC1, through the membrane line MBL1, a charge corresponding to the magnitude of the current source associated with the weight W<7:0> stored in the weight register wReg.

Referring to FIG. 4 again, the weight W stored in the synapse SYn1 is converted into a charge value through the I-DAC implemented according to the corresponding binary value, and it is determined whether this charge value is to be subtracted from the membrane capacitor Cm1 through the MOSFET switch TRsw. In other words, when an input spike signal is applied through the axon line and the MOSFET switch TRsw is turned on, a charge corresponding to the magnitude of the current source determined by the binary weight value applied to the I-DAC is subtracted from the membrane capacitor Cm1.

For each current source provided in the I-DAC, a reference bias current may be supplied. This reference bias current is provided by a separately configured bias current generation circuit 1200 and delivered to each current source. The magnitude of the current generated by each current source may increase exponentially in powers of two to correspond to the binary weights stored as digital values. Such a configuration can be easily implemented by adjusting the MOSFET size (width/length, W/L ratio) of the current source. Although FIG. 4 illustrates an example of an 8-bit I-DAC, the bit width of the synapse is not limited to 8 bits and may vary depending on the intended application.

FIG. 5 is a schematic diagram illustrating a bias current generation circuit of FIG. 1 according to an embodiment of the present disclosure. Referring to FIG. 5, the bias current generation circuit 1200 may include a first group of transistors forming a synapse bias path, a second group of transistors forming a current correction path, and a third group of transistors for bias current control. FIG. 5 may be described in conjunction with FIG. 1.

Referring to FIGS. 1 and 5, the bias current generation circuit 1200 generates and outputs a bias current BC and establishes the potential at node N2, which is connected to the synapse circuits SY11–SYnn, as a bias voltage BV. The bias current generation circuit 1200 of FIG. 1 is provided separately from the spiking neural network 1100, and generates the bias current BC and the bias voltage BV for the current sources of the synapse circuits SY11–SYnn implemented inside the spiking neural network 1100. The initial bias voltage inside the bias current generation circuit 1200 is obtained through reference voltages (bp1_BMR and bp2_BMR) that are robust against temperature and supply voltage variations. Because the general method of implementing such reference voltages is well known, detailed descriptions thereof are omitted from this document. Through the reference voltages bp1_BMR and bp2_BMR, a reference bias current is generated by transistors in a bias current generation group (fourth group). The third group of transistors—also referred to as a bias current control section and controlled by a binary code (hereinafter also referred to as a bias code)—may be PMOS transistors, and may be connected in series with the transistors of the bias current generation group (fourth group).

In one example, the third group of transistors may include PMOS transistors that selectively supply exponential currents. According to the binary code B_code<7:0> applied to the third group of transistors, exponential currents may be selectively applied to the current correction path and the synapse bias path. Depending on the value of B_code, the amounts of currents (Ical, Ibias) applied to the current correction path and the synapse bias path may be linearly adjusted. The current correction path and the synapse bias path are connected by the same current mirror, such that the same amount of current flows through both paths. The current Ical flowing through the current correction path is delivered to the self-correction circuit 1210. The self-correction circuit 1210 determines whether the current applied to the synapse circuit matches a target value, and performs a self-correction process by outputting the binary code B_code<7:0>.

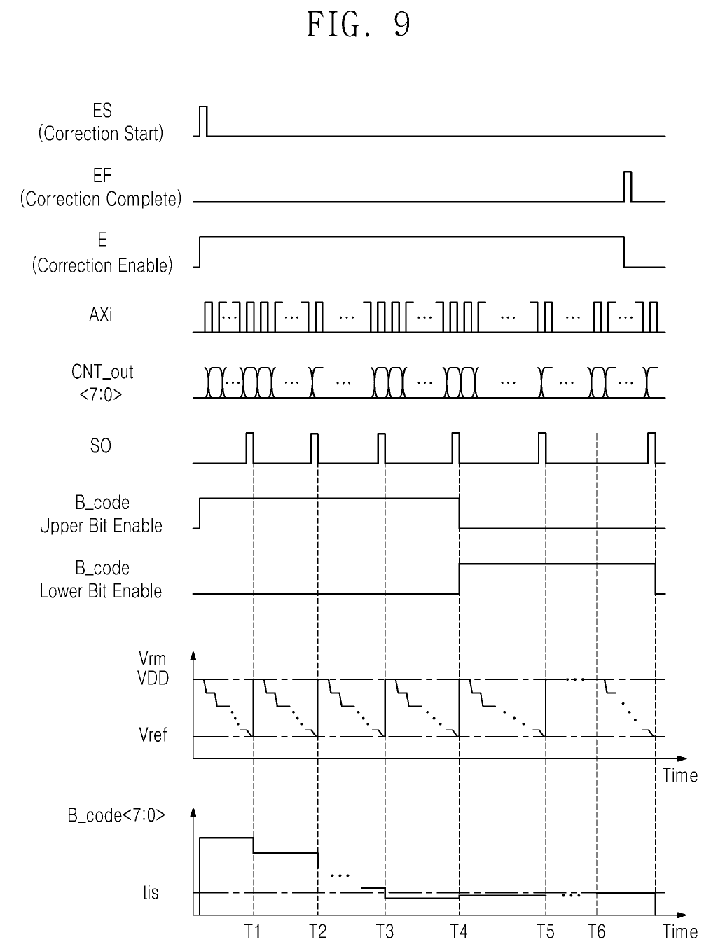

In one example, the bias current generation circuit 1200 may further include a correction enable circuit 1220. The correction enable circuit 1220 may receive a correction start signal ES and a correction finish signal EF, and may output a correction enable signal E based on these signals. The correction enable signal E may be provided to the self-correction circuit 1210. The correction enable signal E may be a signal that enables or disables the self-correction circuit 1210 based on the correction start signal ES and/or the correction finish signal EF. The correction start signal ES, correction finish signal EF, and correction enable signal output from the correction enable circuit 1220 will be described with reference to FIG. 9.

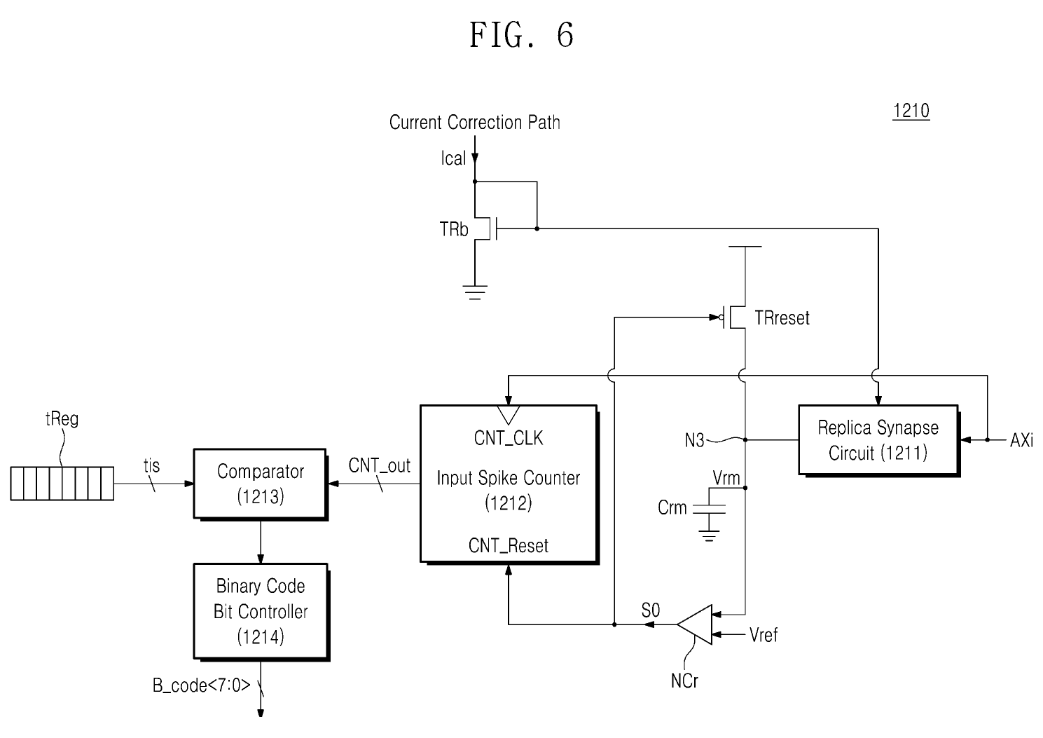

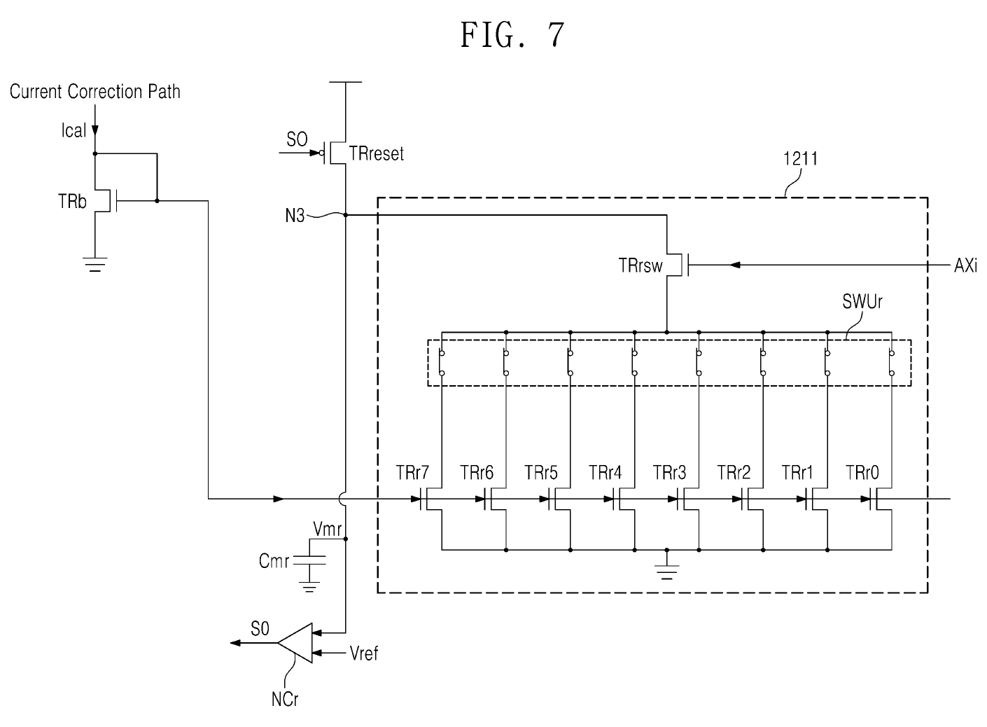

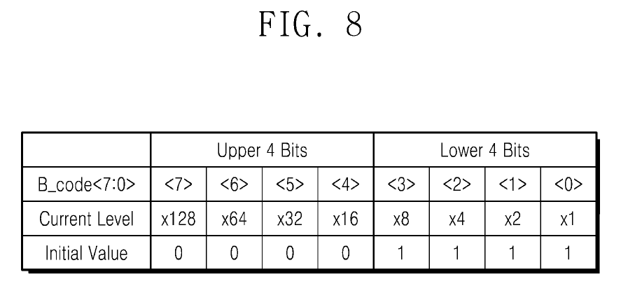

FIG. 6 is a schematic diagram illustrating a self-correction circuit of FIG. 5 according to an embodiment of the present disclosure. FIG. 7 is a schematic diagram illustrating a replica synapse circuit of FIG. 6 according to an embodiment of the present disclosure. FIG. 8 is a table exemplarily showing a binary code B_code<7:0> according to an embodiment of the present disclosure. FIGS. 6 to 8 will be described together in the following paragraphs, in conjunction with FIGS. 1 to 5.

Referring to FIG. 6, the self-correction circuit 1210 may include a replica synapse circuit 1211, a replica membrane capacitor Cmr, a replica neuron circuit NCr, an input spike counter 1212, a comparator 1213, a target input spike register tReg, and a binary code bit controller 1214. The circuits and elements included in FIG. 6 may be implemented with the same structure and size as those of the circuits and elements implemented in the spiking neural network circuit 1100 where actual charge computation is performed.

The target input spike register tReg may store a value related to the number of input test spikes that a designer has predetermined as a design target (also referred to as a spike-count target register). The comparator 1213 may compare, under the control of a control signal, the value stored in the target input spike register tReg with the spike count of the input spike signal measured by the input spike counter 1212. The binary code bit controller 1214 may generate, modify, and store a binary code (also referred to as a bias code) based on the comparison result from the comparator 1213. The binary code bit controller 1214 may also include a B_code register for storing the binary code.

The operation of self-correction performed by the self-correction circuit 1210 proceeds as follows. First, the general operation of the replica synapse circuit 1211, the replica neuron circuit NCr, and the replica membrane capacitor Cmr is the same as that of the circuits inside the spiking neural network in which charge computation is performed. Whether the self-correction operation is performed may be determined by a correction enable signal controlled by a correction start signal ES and/or a correction finish signal EF. When the correction enable signal is “1”, the correction operation is initiated; when it is “0”, the correction operation stops.

Referring to FIG. 7, the replica synapse circuit 1211 may include a replica synapse transistor TRrsw, a replica switch unit SWUr, and transistors TRr0–TRr7. It is assumed that the weight values of the replica synapse circuit 1211 are all set to “1” (that is, all switches in the switch unit SWUr are turned on or closed). When the self-correction operation begins, the potential Vmr of the replica membrane capacitor Cmr is reset to an initial value VDD. A reset transistor TRreset, connected to the replica membrane capacitor Cmr through node N3, may reset the potential Vmr of the replica membrane capacitor Cmr based on an output spike signal from the replica neuron circuit NCr.

An input spike signal AXi (a pulse having a constant period, also referred to as an input pulse signal) may be applied to the replica synapse circuit 1211 through a specific axon line AXLi (i being one of 1 to n). Accordingly, charge is discharged from the replica membrane capacitor Cmr through the replica synapse circuit 1211, thereby decreasing the potential Vmr of the replica membrane capacitor Cmr. As the continuous input spike signal AXi is applied, the potential Vmr of the replica membrane capacitor Cmr decreases, and when it becomes less than a predetermined threshold potential Vref, the replica neuron circuit NCr may generate an output spike signal SO. During the correction process, the input spike signal AXi is provided as a clock (CNT_CLK) to the input spike counter 1212, which increases its count value from an initial reset value. When the replica neuron circuit NCr generates an output spike signal SO, the comparator 1213 performs a comparison operation between the target input spike count and the current count value, and the input spike counter 1212 then resets the count value back to the initial state.

The bias current Ical may be applied to the replica synapse circuit 1211 through the current correction path (including TRb) inside the bias current generation circuit 1200. The bias current Ical may be finely adjusted according to the binary code B_code<7:0> output during the self-correction process. The current Ical has the same value as the bias current Ibias (or BC) used in the synapse circuits SY11–SYnn of the actual charge-computation-based spiking neural network 1100. Accordingly, when the self-correction process achieves the target input spike count value predetermined during the design phase, the synapse circuits SY11–SYnn inside the implemented spiking neural network 1100 can have the same bias current as the design target.

During the self-correction process, the input spike counter 1212 counts the number of input spike signals. When the potential Vmr of the replica membrane capacitor Cmr becomes less than the threshold potential Vref, the replica neuron circuit NCr generates an output spike signal SO, and the comparator 1213 compares the counted value with the target value. In one example, if the counted value equals the target value, the correction procedure is completed. The correction enable circuit 1220 receives the correction finish signal EF and outputs the correction enable signal E as “0” to stop the correction operation of the self-correction circuit 1210.

As one example, when the spike count counted by the input spike counter 1212 is less than the target input spike count, the upper bits B_code<7:4> of the binary code B_code<7:0> may be increased one bit at a time. As illustrated in the example table of FIG. 8, assuming that the bit width of B_code is 8 bits, B_code<7:0> may be initially set to “00001111” at the beginning of the self-correction operation. The upper four bits B_code<7:4> are initialized to “0000”, and the transistors in the bias current control group receiving the corresponding signals are all turned on, allowing the maximum bias current Ical to flow. That is, the correction operation starts with the maximum bias current that can be provided by the upper bits of the initial B_code, under the assumption that the initially counted number of input spikes will be less than the target value.

If the counted number of input spikes is less than the target input spike count, the upper four bits B_code<7:4> are increased one by one from B_code<4>, and the transistors in the bias current control group receiving the corresponding signals are sequentially turned off, thereby gradually generating smaller Ical values. As the self-correction operation proceeds, the counted number of input spikes increases. When the counted input spike count becomes greater than the target input spike count, the correction of the upper four bits B_code<7:4> stops, and the correction of the lower four bits B_code<3:0> begins. The lower bits B_code<3:0> are initially set to “1111” corresponding to the lowest control current value. The transistors in the bias current control group receiving the signals from the lower four bits B_code<3:0> are all turned off, resulting in the smallest bias current Ical.

During the correction process, if the number of input spike signals AXi (counted by the input spike counter 1212) is still smaller than the target spike count, the lower bits B_code<3:0> are decreased one by one from the least significant bit B_code<0>, and the transistors in the bias current control group corresponding to the lower bits are sequentially turned on, thereby gradually generating larger Ical values. Accordingly, as Ical increases slightly, the number of input spike signals AXi (counted by the input spike counter 1212) gradually decreases. When the number of input spike signals AXi becomes equal to the target input spike count, the self-correction circuit 1210 terminates the self-correction operation (the correction enable circuit 1220 receives the correction finish signal EF and outputs the correction enable signal E with a value of “0”). Using the finalized binary code (the corrected final binary code), the bias current BC delivered to the synapses SY11–SYnn of the spiking neural network 1100 is determined, and normal charge-computation operation is subsequently performed.

FIG. 9 is a timing diagram illustrating operation waveforms for describing the operation of the self-correction circuits of FIGS. 5 and 6 according to an embodiment of the present disclosure. FIG. 9 may be described in conjunction with FIGS. 1 through 8.

As described with reference to FIG. 5, a correction start signal ES having a logic value of “1”, which is output from the correction enable circuit 1220, is applied to the self-correction circuit 1210, thereby initiating the self-correction operation of the bias current generation circuit 1200. The input spike counter 1212 counts the number of spikes in an input spike signal AXi. Here, the input spike signal AXi may correspond to one of the axon lines (AXi, where i is one of 1 through n).

Referring to FIG. 9, when the replica neuron circuit NCr outputs an output spike signal SO, the comparator 1213 compares the number of spikes counted by the input spike counter 1212 with the target input spike count. Based on a comparison result indicating that the counted spike number is less than the target input spike count, the binary code bit controller 1214 modifies the upper four bits B_code<7:4> of the binary code by increasing them by one bit. According to the signal based on the modified binary code output from the binary code bit controller 1214, the transistors included in the bias current control group are controlled, and the correction current Ical is decreased accordingly.

The comparison operation between the target value and the counted value, and the binary code correction operation, are repeatedly performed. When the number of spikes counted by the input spike counter 1212 CNT_out<7:0> becomes greater than the target spike count, the binary code bit controller 1214 outputs a B_code-upper-bit enable signal of “0” and a B_code-lower-bit enable signal of “1”, such that the adjustment of the lower bits B_code<3:0> of the binary code begins. As the lower bits B_code<3:0> of the binary code are adjusted, the Ical value may increase slightly. When the number of spikes counted by the input spike counter 1212 CNT_out<7:0> becomes equal to the target spike count, the correction enable circuit 1220 receives a correction finish signal EF having a logic value of “1” and outputs a correction enable signal having a logic value of “0”, thereby providing it to the self-correction circuit 1210 and completing the self-correction operation.

In the example operation illustrated together with FIG. 9, the target input spike count may be thirty-two (32 numbers). When, based on the correction start signal ES, the correction enable circuit 1220 outputs a correction enable signal having a logic value of “1”, the correction process begins. The initial correction may be performed on the upper four bits B_code<7:4> of the binary code. In this state, the B_code-upper-bit enable signal may be “1”, and the B_code-lower-bit enable signal may be “0”. At time t = T1, a first output spike signal may be generated. For example, by time t = T1, the input spike counter 1212 may have counted sixteen spikes CNT_out<7:0> = 16. As the upper bits B_code<7:4> are modified, the overall value of B_code<7:0> decreases, and the next output spike signal based on the bias current corresponding to the modified B_code<7:0> may be generated at time t = T2. The correction operation for the upper four bits B_code<7:4> of the binary code may continue until the number of counted input spikes CNT_out<7:0> becomes greater than the target input spike count (for example, until approximately t = T4). For instance, between times t = T3 and t = T4, the counted number of input spikes may reach thirty-five (35 numbers).

At time t = T4, the correction operation for the upper four bits B_code<7:4> is stopped, and starting from t = T4, the correction operation for the lower four bits B_code<3:0> begins. At t = T4, the B_code-upper-bit enable signal changes to “0”, and the B_code-lower-bit enable signal changes to “1”. During the correction operation for the lower four bits B_code<3:0>, as B_code<3:0> is modified, the overall value of B_code<7:0> increases. The correction operation for the lower four bits B_code<3:0> may continue until the number of input spikes CNT_out<7:0> becomes equal to the target input spike count (for example, until approximately t = T6). Finally, when the number of spikes in the input spike signal AXi becomes equal to the target input spike count (32 numbers), the self-correction operation is terminated. At the time of termination, the correction enable circuit 1220 receives the correction finish signal EF and outputs a correction enable signal E having a logic value of “0”, which is provided to the self-correction circuit 1210.

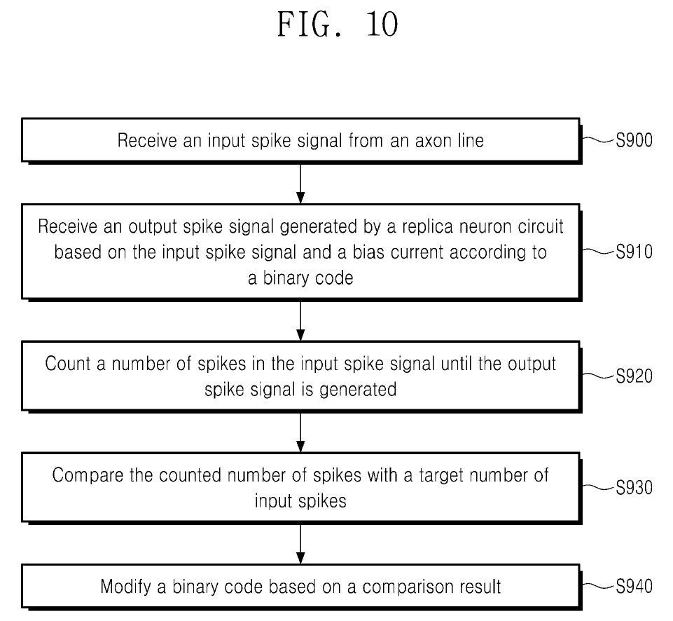

FIG. 10 is a flowchart exemplarily illustrating a method for correcting a bias current according to an embodiment of the present disclosure. The method described with steps S900 through S940 in FIG. 10 may be used to correct a bias current provided to a spiking neural network circuit that generates an output spike signal based on an input spike signal from an axon line. FIG. 10 may be described together with FIGS. 1 through 9.

In step S900, the replica synapse circuit 1211 and the input spike counter 1212 receive an input spike signal from one of the axon lines AXL1–AXLn.

In step S910, the input spike counter 1212 receives an output spike signal generated by the replica neuron circuit NCr based on the input spike signal and the bias current determined according to the binary code.

In step S920, the input spike counter 1212 counts the number of spikes in the input spike signal until the output spike signal is generated.

In step S930, the comparator 1213 compares the counted number of spikes with the target input spike count.

In step S940, the binary code bit controller 1214 modifies the binary code based on the comparison result obtained in step S930. For example, the binary code bit controller 1214 may, based on a comparison result indicating that the counted number of spikes is less than the target input spike count, increase the least significant bit among the upper bits B_code<7:4> of the binary code by one bit. Conversely, based on a comparison result indicating that the counted number of spikes is greater than the target input spike count, the binary code bit controller 1214 may decrease the least significant bit among the lower bits B_code<3:0> of the binary code by one bit.

In other words, for an initial binary code, the binary code bit controller 1214 first increases, one by one, the least significant bit among the upper bits B_code<7:4>. When the number of spikes in the output spike signal becomes greater than the target input spike count, the controller 1214 increases, one by one, the least significant bit among the lower bits B_code<3:0> until the number of spikes in the output spike signal becomes equal to the target input spike count.

The bias current correction method described with FIG. 10 may start with a predetermined initial binary code (the correction procedure may start together with the correction start signal ES input to the correction enable circuit 1220 of FIG. 5). In this method, the replica neuron circuit NCr generates an output spike signal based on the bias current corresponding to the initial binary code, and the input spike counter 1212 counts the number of input spike signals until the output spike signal is generated. The comparator 1213 compares the counted spike number with the target input spike number.

In other words, based on a comparison result indicating that the spike count is less than the target input spike count, the binary code bit controller 1214 increases the least significant bit among the upper bits B_code<7:4> of the initial binary code by one bit to modify the binary code. As illustrated with reference to FIG. 9, starting from the binary code initially stored in the binary code bit controller 1214, the controller sequentially increases the least significant bit among the upper bits B_code<7:4> to increase the spike count in the output spike signal on a coarse scaling level. When the spike count in the output spike signal becomes greater than the target input spike count, the binary code bit controller 1214 decreases, one by one, the least significant bit among the lower bits B_code<3:0> based on the comparison result, thereby reducing the spike count in the output spike signal on a finer scaling level. Ultimately, the number of spikes in the output spike signal becomes equal to the target input spike count, and the correction procedure is terminated (as triggered by the correction finish signal EF input to the correction enable circuit 1220 of FIG. 5).

The foregoing description illustrates specific embodiments for carrying out the present invention. However, the present invention is not limited to the above-described embodiments and also encompasses embodiments that can be easily modified or altered by those skilled in the art. In addition, the present invention includes technologies that can be readily implemented through modifications based on the described embodiments. Therefore, the scope of the present invention should not be limited to the foregoing embodiments but should be defined by the appended claims and their equivalents.

The embodiments of the present disclosure may be implemented not only through the apparatuses and/or methods described above but also through a program that realizes functions corresponding to the configurations of the embodiments, or through a recording medium on which such a program is stored. Such implementations can be readily made by those skilled in the art based on the disclosure described above.

Although the embodiments of the present disclosure have been described in detail, the scope of the present disclosure is not limited thereto. Various modifications and improvements utilizing the basic concept of the present disclosure, which can be easily conceived by those skilled in the art, are also included within the technical scope of the present disclosure.

What is claimed is:

1. An apparatus comprising a spiking neural network circuit configured to generate an output spike signal based on an input spike signal received from an axon line, the apparatus comprising:
a bias current generation circuit configured to generate a bias current;
a synapse circuit including a weight register storing a weight value and configured to perform a charge operation based on the input spike signal, the bias current, and the weight value;
a membrane capacitor having a potential determined based on the charge operation of the synapse circuit; and
a neuron circuit configured to generate a first output spike signal based on a comparison between the potential of the membrane capacitor and a threshold potential,
wherein the bias current generation circuit comprises a self-correction circuit,
wherein the self-correction circuit comprises a target input spike register storing a value related to a target number of input spikes, and
wherein the self-correction circuit is configured to correct the bias current generated by the bias current generation circuit based on the value related to the target number of input spikes.

2. The apparatus of claim 1,
wherein the neuron circuit is configured to generate the first output spike signal based on a comparison result indicating that the potential of the membrane capacitor is lower than the threshold potential.

3. The apparatus of claim 1,
wherein the self-correction circuit is configured to output a binary code for correcting the bias current.

4. The apparatus of claim 1,
wherein the self-correction circuit comprises:
a replica synapse circuit configured to receive the input spike signal from the axon line and to perform a charge operation;
a replica membrane capacitor having a potential determined based on the charge operation of the replica synapse circuit;
a replica neuron circuit configured to generate a second output spike signal based on the potential of the replica membrane capacitor;
an input spike counter configured to receive the input spike signal from the axon line and the second output spike signal from the replica neuron circuit, and to count a number of spikes in the input spike signal until the second output spike signal is generated;
a comparator configured to compare the counted number of spikes with the target number of input spikes; and
a binary code bit controller configured to modify the binary code based on a comparison result of the comparator.

5. The apparatus of claim 4,
wherein the binary code bit controller is configured to modify the binary code by increasing a least significant bit within upper bits of the binary code by one bit based on a comparison result indicating that the counted number of spikes is less than the target number of input spikes.

6. The apparatus of claim 4,
wherein the binary code bit controller is configured to modify the binary code by decreasing a least significant bit within lower bits of the binary code by one bit based on a comparison result indicating that the counted number of spikes is greater than the target number of input spikes.

7. The apparatus of claim 4,
wherein the binary code bit controller stores a predetermined initial binary code,
wherein the replica neuron circuit generates the second output spike signal based on a first bias current corresponding to the initial binary code,
wherein the input spike counter counts the number of spikes in the input spike signal until the second output spike signal is generated,
wherein the comparator compares the counted number of spikes with the target number of input spikes, and
wherein the binary code bit controller modifies the initial binary code to a first binary code by increasing a least significant bit within upper bits of the initial binary code by one bit based on a comparison result indicating that the counted number of spikes is less than the target number of input spikes.

8. The apparatus of claim 4,
wherein the input spike counter resets a count value when the second output spike signal is generated by the replica neuron circuit.

9. The apparatus of claim 4,
wherein the self-correction circuit is configured to terminate a correction procedure of the bias current based on a comparison result of the comparator indicating that the number of spikes of the input spike signal counted by the input spike counter is equal to the target number of input spikes.

10. The apparatus of claim 1,
wherein the bias current generation circuit comprises a current correction path connected to the self-correction circuit, and a synapse bias path through which a bias current provided to the spiking neural network flows,
wherein the current correction path and the synapse bias path are formed of a same current mirror including transistors, and
wherein a magnitude of a current flowing through the current correction path is equal to a magnitude of a current flowing through the synapse bias path.

11. A bias current generation circuit configured to provide a bias current to a spiking neural network circuit that generates an output spike signal based on an input spike signal received from an axon line and to correct the bias current, the bias current generation circuit comprising:
a first group of transistors forming a synapse bias path for providing the bias current to the spiking neural network circuit;
a second group of transistors forming a current correction path and configured as a same current mirror as the first group of transistors;
a third group of transistors including transistors for controlling the bias current; and
a self-correction circuit configured to provide a control signal corresponding to a binary code for correcting the bias current to the third group of transistors,
wherein the self-correction circuit comprises:
a replica synapse circuit configured to receive the input spike signal from the axon line and to perform a charge operation;
a replica membrane capacitor having a potential determined based on the charge operation of the replica synapse circuit;
a replica neuron circuit configured to generate an output spike signal based on the potential of the replica membrane capacitor;
an input spike counter configured to receive the input spike signal from the axon line and the output spike signal from the replica neuron circuit, and to count a number of spikes in the input spike signal until the output spike signal is generated;
a target input spike register configured to store a value related to a target number of input spikes;
a comparator configured to compare the counted number of spikes with the target number of input spikes; and
a binary code bit controller configured to modify the binary code based on a comparison result of the comparator.

12. The bias current generation circuit of claim 11,
wherein the binary code bit controller is configured to modify the binary code by increasing a least significant bit within upper bits of the binary code by one bit based on a comparison result indicating that the counted number of spikes is less than the target number of input spikes.

13. The bias current generation circuit of claim 11,
wherein the binary code bit controller is configured to modify the binary code by decreasing a least significant bit within lower bits of the binary code by one bit based on a comparison result indicating that the counted number of spikes is greater than the target number of input spikes.

14. The bias current generation circuit of claim 11,
wherein the binary code bit controller stores a predetermined initial binary code,
wherein the replica neuron circuit generates the output spike signal based on a first bias current corresponding to the initial binary code,
wherein the input spike counter counts the number of spikes in the input spike signal until the output spike signal is generated,
wherein the comparator compares the counted number of spikes with the target number of input spikes, and
wherein the binary code bit controller modifies the initial binary code to a first binary code by increasing a least significant bit within upper bits of the initial binary code by one bit based on a comparison result indicating that the counted number of spikes is less than the target number of input spikes.

15. The bias current generation circuit of claim 11,
wherein the input spike counter resets a count value when the output spike signal is generated by the replica neuron circuit.

16. The bias current generation circuit of claim 11,
wherein the self-correction circuit is configured to terminate a correction procedure of the bias current based on a comparison result of the comparator indicating that the number of spikes of the input spike signal counted by the input spike counter is equal to the target number of input spikes.

17. A method for correcting a bias current provided to a spiking neural network circuit configured to generate an output spike signal based on an input spike signal from an axon line, the method comprising:
receiving, by a replica synapse circuit and an input spike counter, the input spike signal from the axon line;
receiving, by the input spike counter, the output spike signal generated by a replica neuron circuit based on the input spike signal and a bias current corresponding to a binary code;
counting, by the input spike counter, a number of spikes of the input spike signal until the output spike signal is generated;
comparing, by a comparator, the counted number of spikes with a target number of input spikes; and
modifying, by a binary code bit controller, the binary code based on a comparison result.

18. The method of claim 17,
wherein modifying the binary code based on the comparison result comprises modifying the binary code by increasing a least significant bit within upper bits of the binary code by one bit based on a comparison result indicating that the counted number of spikes is less than the target number of input spikes.

19. The method of claim 17,
wherein modifying the binary code based on the comparison result comprises modifying the binary code by decreasing a least significant bit within lower bits of the binary code by one bit based on a comparison result indicating that the counted number of spikes is greater than the target number of input spikes.

20. The method of claim 17,
wherein the method further comprises:
generating, by the replica neuron circuit, the output spike signal based on a first bias current corresponding to a predetermined initial binary code;
counting, by the input spike counter, a number of spikes of the input spike signal until the output spike signal is generated;
comparing, by the comparator, the counted number of spikes with a target number of input spikes; and
modifying the initial binary code to a first binary code by increasing a least significant bit within upper bits of the initial binary code by one bit based on a comparison result indicating that the counted number of spikes is less than the target number of input spikes.
